(19) United States
(12) Patent Application Publication
(10) Pub. No.: US 2009/0313412 A1
(43) Pub. Date: Dec. 17, 2009

(54) Hub Capable of Enhancing Power Supplying Capability

(76) Inventor: Cheng-Su Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/138,435

(22) Filed: Jun. 13, 2008

(51) Int. Cl. G06F 13/20

(52) U.S. Cl. 710/313

(57) ABSTRACT

A hub capable of enhancing power supplying capability includes a plurality of ports, a first interface coupled to a first port of a computer system, a second interface coupled to a second port of the computer system, the second port with a format different from a format of the first port, a diversity unit coupled to the plurality of ports, a data processing unit coupled between the first interface and the diversity unit for processing data exchange between the plurality of ports and the first port via the first interface and the diversity, and a power supply unit coupled between the first interface, the second interface and the diversity interface for receiving power output by the first port and the second port via the first interface and the second interface, so as to provide power in conformation to a predefined requirement to the plurality of ports via the diversity unit.

### BACKGROUND OF THE INVENTION

1. Field of the Invention

The present invention relates to a hub capable of enhancing power supplying capability, and more particularly, to a hub capable of effectively driving peripheral devices and making the peripheral devices function properly, so as to improve portability and enhance convenience.

2. Description of the Prior Art

Universal Serial Bus (USB) is regarded as a convenient and low-cost data connection method between a computer and a plurality of peripheral devices, such as printer, joystick, keyboard, mouse, scanner, modem, digital camera, portable hard drive, etc. USB supports Hot Attach and Detach function and Plug and Play function such that a user can add and remove USB peripheral devices to a computer without turning off or rebooting the computer system, while internal resources of the computer system can be allocated properly and set for contention-free. At the time when a USB device connects the computer system, the computer system will automatically detect the presence of the device and start running the right driver program associated with the device. The USB is designed to have good expandability, easy installation and high data rate transfer capability, and the user can install a USB hub to increase the number of connecting devices by themselves.

According to the prior art, a USB Root Hub can provide 5 volt of supply voltage and 500 mA of supply current, at most, for reason of alleviating the power requirement of the computer system and protecting the USB Host Controller hardware. When a peripheral device requires a current level more than 500 mA, the only alternative would be for the device to be self-powered or have an external power supply for the device, and this may not be an ideal way of using a portable peripheral device.

Briefly speaking, since the USB Root Hub can supply 5 volt of voltage and 500 mA of current to the USB device at its maximal power level. Conventionally, when some USB device requires more than 500 mA of current, the device should be able to be self-powered or have an external power supply, which brings inconvenience to the user and unbeneficial to the portability of the peripheral device.

### SUMMARY OF THE INVENTION

It is therefore a primary objective of the claimed invention to provide a hub capable of enhancing power supplying capability.

The present invention discloses a hub capable of enhancing power supplying capability, which comprises a plurality of ports; a first interface coupled to a first port of a computer system; a second interface coupled to a second port with a format different from a format of the first port in the computer system; a diversity unit coupled to the plurality of ports; a data processing unit coupled between the first interface and the diversity unit for processing data exchange between the plurality of ports and the first port via the first interface and the diversity unit; and a power supply unit coupled to the first interface, the second interface and the diversity interface for receiving power output from the first port and the second port via the first interface and the second interface, so as to provide power in conformity with a predefined requirement to the plurality of ports via the diversity unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a hub capable of enhancing power supplying capability in accordance with a preferred embodiment of the present invention.

### DETAILED DESCRIPTION

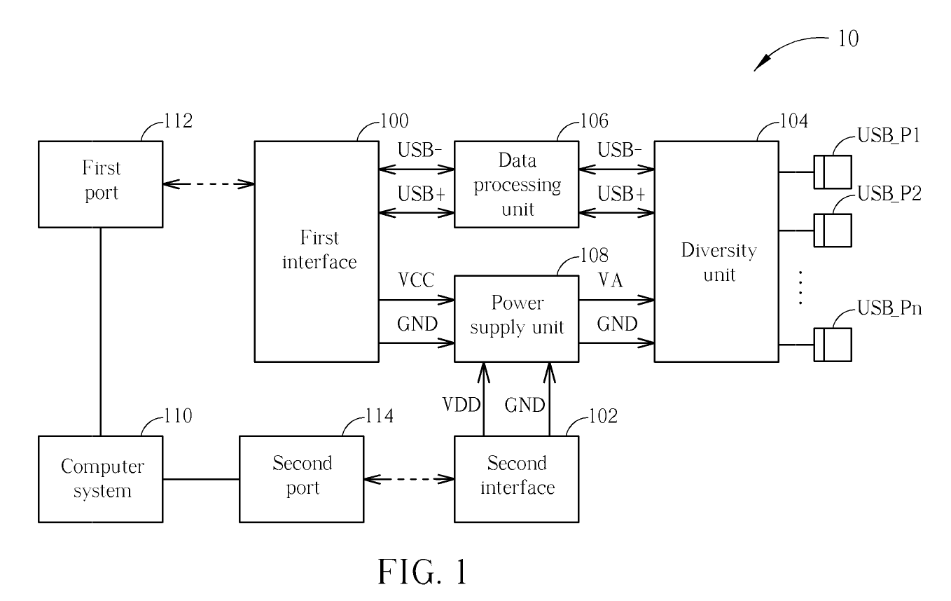

FIG. 1 shows a schematic diagram of a hub 10 capable of enhancing power supplying capability in accordance with a preferred embodiment of the present invention. The hub 10 is preferably a USB hub, and includes ports USB_P1˜USB_Pn, a first interface 100, a second interface 102, a diversity unit 104, a data processing unit 106 and a power supply unit 108. The first interface 100 and the second interface 102 are coupled to a first port 112 and a second port 114 of a computer system 110. The format of the first port 112 differs from that of the second port 114. For instance, the first port 112 is a USB port and the second an IEEE 1394. The data processing unit 106 is coupled between the first interface 100 and diversity unit 104, and utilized for processing data exchange between the ports USB_P1˜USB_Pn and the first port 112 via the first interface 100 and the diversity unit 104. Taking USB hub as an example, the data processing unit 106 can perform exchange of data signals USB− and USB+ between the first interface 100 and the diversity unit 104. The power supply unit 108 is coupled to the first interface 100, the second interface 102 and the diversity unit 104, and utilized for receiving power output from the first port 112 and the second port 114 via the first interface 100 and the second interface 102, so as to provide power in conformance with a predefined requirement to the ports USB_P1˜USB_Pn via the diversity unit 104. Briefly speaking, if power signals output from the first port 112 and the second port 114 are VCC and VDD respectively, while a ground signal output from the first port 112 and the second port 114 is GND, the power supply unit 108 can combined the power signals VCC and VDD to generate a power signal VA for the ports USB_P1˜USB_Pn. In other words, the hub 10 can receive power output from two different ports of the computer system, and after proper transformation, the hub 10 can output power according to the predefined requirement. Under these circumstances, while a peripheral device attached in one of the ports USB_P1˜USB_Pn requires more power than the first port 112 can supply, according to the present invention, the hub 100 can redirect the power output from the second port 114 to the ports USB_P1˜USB_Pn, such that the peripheral device can function properly, and the portability of the peripheral device can be improved.

By employing the present invention, the hub 10 can use both the power of the first port 112 and the power of the second port 114 to reinforce the power supplying capability to the peripheral devices. Notably, FIG. 1 is the schematic diagram of the preferred embodiment of the present invention, and those skilled in the art can make modifications and alternations accordingly. For instance, the ports USB_P1˜USB_Pn and the first port 112 are preferably USB ports, and the second port 114 is preferably an IEEE 1394. Since an IEEE 1394 port has better power supplying capability (12V, 1.5A), thus when the second port 114 is an IEEE 1394 port, a power supply level better than that of a USB (5V, 500 mA) alone can be achieved, and the hub 10 can drive the peripheral devices more effectively, especially when the number of the peripheral devices is large, the normal operation of the peripheral devices can be assured.

In the prior art, a USB Root Hub can provide 5 volt of supply voltage and 500 mA of supply current maximally. If a peripheral device needs more than 500 mA of current in order to function properly, the device has to be self-powered or powered by an external power source, and this will decrease convenience and detriment portability. Compared with the prior art, in the present invention, the power supply unit 108 receives power output from the first port 112 and the second port 114 via the first interface 100 and the second interface 114, performs adequate combination and transformation to the input power, and provides output power in conformance with a predefined requirement to the ports USB_P1˜USB_Pn, such that the hub 10 is able to effectively drive the peripheral devices and the user's convenience can be improved.

Therefore, the user only needs to connect the first interface 100 and the second interface 102 to the first port 112 and the second port 114 of the computer system 110 via the hub 10. The hub 10 can increase the power supplying capability, especially when the number of the peripheral devices is relatively large, the peripheral devices can function normally without being self-powered or powered by external power sources.

In summary, the present invention can receive power output from two different ports of the computer system, and provide power in conformance with a predefined requirement after proper transformation. Under the condition that a peripheral device requires more power than the first port 112 can supply, the present invention can redirect the power output from the second port 114 to the plurality of ports USB_P1˜USB_Pn. The hub 10 can thus drive the peripheral devices effectively, especially when the number of the peripheral devices is relatively large. The present invention can make the peripheral devices function normally without being self-powered or powered by external power sources, and eventually the user's convenience and device's portability can be improved.

Those skilled in the art will readily observe that numerous modifications and alterations of the device and method may be made while retaining the teachings of the invention.

What is claimed is:

1. A hub capable of enhancing power supplying capability, comprising:
a plurality of ports;
a first interface coupled to a first port of a computer system;
a second interface coupled to a second port with a format different from a format of the first port in the computer system;
a diversity unit coupled to the plurality of ports;
a data processing unit coupled between the first interface and the diversity unit for processing data exchange between the plurality of ports and the first port via the first interface and the diversity unit; and
a power supply unit coupled to the first interface, the second interface and the diversity interface for receiving power output from the first port and the second port via the first interface and the second interface, so as to provide power in conformity with a predefined requirement to the plurality of ports via the diversity unit.

2. The hub of claim 1, wherein the plurality of ports are a plurality of Universal Serial Bus ports.

3. The hub of claim 1, wherein the first port is a Universal Serial Bus port.

4. The hub of claim 1, wherein the second port is an IEEE 1394 port.

5. The hub of claim 1, wherein the second port is a PC Express port.
